(19) United States
(12) Patent Application Publication
(10) Pub. No.: US 2016/0055576 A1
(43) Pub. Date: Feb. 25, 2016

(54) SYSTEM AND METHOD FOR A TWO-STEP NEGOTIATION PROCESS

(71) Applicant: Ian Reddy, Austin, TX (US)

(72) Inventor: Ian Reddy, Austin, TX (US)

(21) Appl. No.: 14/466,245

(22) Filed: Aug. 22, 2014

(51) Int. Cl. G06Q 30/06

(52) U.S. Cl. CPC G06Q 30/0645; G06Q 50/188

(57) ABSTRACT

Disclosed are systems and methods for quickly completing an online transaction for a vacation rental property. The systems and methods are based upon a “two-click” online transaction process occurring between a renter and property owner. The two-click process comprises an initial price offer set by the owner, a negotiated offer requested by a renter, and a booking offer communicated by the owner in response to the negotiated offer. The negotiated offer can be the same as the initial price offer or a reduced price from that of the initial offer. The booking offer can comprise either an acceptance of the negotiation offer, whereby the renter is automatically charged and booked for the property, or a response counter-offer to the negotiation offer, whereby if the renter accepts, the deal is automatically booked, and if the renter declines, the deal is concluded with no agreement being reached.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure generally relates to online vacation rental management, and more particularly towards systems and methods for managing negotiations between an owner and renter for a short-term vacation rental.

### RELATED ART

In recent years, many Internet-based vacation rental systems have emerged that enable owners with the ability to rent their property to renters. Such property can include, but are not limited to, land, homes, motor homes, apartments, and the like. Indeed, a recent trend has evidenced a desire of renters to spend their vacation time in something other than a hotel room. Thus, the current marketplace has created a large demand for, and growth in, non-hotel vacation properties.

### SUMMARY

The disclosed systems and methods provide a streamlined online reservation and booking system. That is, according to some embodiments, the present disclosure provides systems and methods for quickly completing an online transaction related to a vacation rental property in accordance with a “two-click” transaction process occurring between a renter and owner of a property. The process is based upon an initial price offer comprising an initial price term set by the owner and a negotiated offer comprising a negotiated price term requested by the renter. Upon viewing the initial price term, the renter can submit a negotiated price term for acceptance by the owner. The negotiated price term can be the same as the initial price term or a reduced version of the price term. For example, if a property is listed at 100 dollar per night (i.e., the initial price term), the negotiated price term submitted for approval by the renter can also be the $100/night price, or a reduced version, for example, $80/night. According to some embodiments, the negotiated price term can only be reduced according to a predetermined limit or threshold, which can be set by the owner or website.

In response, the owner has the ability to accept, decline or counter-offer. In some embodiments, the owner's decision must be made within a predetermined period of time, such as, for example, within 24 hours of receiving a bid from a renter. Such time period can be set by the owner, system manager, web site administrator, agent, company, property manager, a third party (e.g., management company) and the like. That is, the owner can accept the offer from the renter, whereby the transaction is completed as the property is automatically booked and the user is automatically charged according to the accepted terms. If the owner declines, the process is completed with no deal occurring between the parties. In some embodiments, if the owner does not respond within the time period, then the negotiation process ends (e.g., the transaction is declined or there is no-deal). In some embodiments, if the owner does not respond to the renter's offer, then the deal is made according to the renter's offer, and the renter is automatically charged upon the expiration of such time period, as discussed in more detail below.

If the owner counter-offers, the owner is effectively responding to the renter's negotiated offer with a different price term. In response to the counter-offer, the renter can either accept or decline. In some embodiments, the renter must make a decision within a predetermined period of time, such as, for example, within 24 hours of receiving the counter-offer. Such time period can be set by the owner, property manager, web site administrator, system manager, and the like (similar to the owner's time period). That is, if the renter accepts the counter-offer, the renter is then automatically booked for the property and charged according to the accepted terms. If the renter declines the counter-offer, then the process is completed with no deal occurring between the two parties (e.g., transaction declined). In some embodiments, if the time period for response expires, and the renter has not responded, it will be determined that the renter declines. In some embodiments, however, if the time period for accepting or declining the counter-offer expires, and the renter has not responded, due to the initial interest from the renter, the renter will be determined to have accepted. Such acceptance may also be based upon a price range set by the renter (set in the user's preferences or settings, account or in-line with his/her initial offer), whereby if the counter-offer is within such range, despite not being the same as the initial offer, the renter can be automatically accepted into the deal and charged accordingly, as discussed in more detail below.

According to some embodiments, each offer submitted by the renter is backed by some type of known or to be known financial institution funded payment method. For example, a renter's offer can be backed by a credit card, debit card, Square® Cash, BrainTree®, and the like. Therefore, each time a transaction is accepted, the renter's account is charged. According to some embodiments, the funds will be automatically transferred to the owner's account. In some embodiments, the funds can be placed in an escrow account associated with the owner and/or website (or third party), whereby after verification of the property, renter's credit and/or veracity involving the renters (or owner's) identity and/or the renter's intent to occupy the property (among other verifiable parameters), the funds can then be transferred after a predetermined period of time. For example, a renter can be booked for a property, and after 24 hours, the funds can then be transferred after an accounting is made regarding the owner and/or renter. Therefore, in some embodiments, upon acceptance by the owner of the negotiated offer or acceptance by the renter of the counter-offer, payment is processed respective the renter's account such that funds are then transferred from the renter's account to the owner's account (e.g., credit card transaction where the renter's credit card is charged upon acceptance of an offer).

According to some embodiments, upon completion of the process without a deal occurring, the renter and owner are barred from negotiating for a rental for those same parameters. In order to begin a new negotiation, according to some embodiments, the renter must then initiate a new negotiation process, for differing terms, not inclusive the price term, such as, a different time span.

According to some embodiments, the two-click transaction process is effectuated by a hosting website, where the transactions (or negotiations) occurring between the owner and renter are facilitated through the website hosting the property. The website's functionality may be implemented via renter visiting the site on a computing device, or through an associated mobile application of the website. Therefore, according to some embodiments, the disclosed systems and methods are related to a website providing last-minute vacation rental accommodations. That is, according to some embodiments, the disclosed systems and methods enable renters to search for and submit offers for vacation rentals only from a predetermined number of days (e.g., 30 days) of their stay. Thus, the present disclosure provides efficient, resource abundant and cost-effective systems and methods for assisting owners and customer/renters in booking and remitting payment for vacation rentals. Indeed, the disclosed systems and methods can leverage a user's offers and/or negotiation activity on a website for advertising purposes.

In accordance with one or more embodiments, a method is disclosed which includes, inter alia, receiving, at a computing device over a network, a search request from a user for available property rentals; searching, via the computing device, for a listing of properties based on said search request, said listing comprising property information associated with each property, said property information comprising an initial price set by an owner of each property; causing, via the computing device, said listing of properties to be communicated to said user; receiving, at the computing device, a user offer to reserve a first property of said listing, said user offer comprising a price request below the initial price from the user and payment information associated with an account of said user; determining, via the computing device, a status of said user offer, said status based upon an acceptance, denial or counter-offer from an owner of said first property, said counter-offer comprising a second price set by the first owner in response to said user price request; automatically charging, via the computing device, said account and reserving said first property for said user upon said status indicating said acceptance of said user offer; stopping, via the computing device, further communication between said user and first owner for said first property upon said status indicating said denial of said user offer; and communicating, over the network, said counter-offer to said user upon said status indicating said counter-offer.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for managing negotiations for a last-minute property rentals.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a schematic block diagram illustrating components of a system in accordance with embodiments of the present disclosure;

FIG. 4 is a flowchart illustrating steps performed in accordance with some embodiments of the present disclosure;

FIGS. 5A-5D illustrates non-limiting example embodiments of FIG. 4 in accordance with some embodiments of the present disclosure;

FIG. 6 is a flowchart illustrating steps performed in accordance with some embodiments of the present disclosure; and

FIG. 7 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer, renter or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

For purposes of this disclosure, the term renter, customer, user and guest can be used interchangeably, and for cohesion among the below discussion, the term renter will be used exclusively. That is, a user of the site looking for a vacation rental property will be viewed as a “renter.”

The principles described herein may be embodied in many different forms. The present disclosure provides an improved streamlined system and method for vacation rental bookings that enables an effective “two-click” transaction process. As discussed herein, the two-click process embodies a novel “make offer” algorithm whereby, through computer-implemented steps, an initial offer is either accepted or declined.

By way of background, conventional vacation rental websites host individually owned properties for rent from renters. Conventional vacation rental systems have attempted to satisfy vacation rental demand by allowing owners (and agents of the owners) to post their vacation rental listings in a searchable repository that is available for viewing online. These systems afford the owner, agent and renter the ability, among other functionality, to negotiate price terms, perform a “home swap” (which is in itself a barter transaction where an owner and renter can exchange use of their respective property), or indulge in a timeshare, where shares of the owner's property can be sold according to a predetermined period to various renters (e.g., sold by the week for a portion of a purchase price associated with the property), in addition to other types of transactions known in the art. However, such systems, in addition to other systems and vacation rental platforms known in the marketplace, have shortcomings in the booking process where improvements in online reservation and booking methods are not only desired, but are also required to maintain stability, sustainability and growth in the marketplace.

Vacation rental websites enable an owner to post his/her property online, where the posting includes property information associated with the property. For example, AirBnb®, HomeAway® and GuestDoor®, to name a few, are websites that provides private owners with the ability to post their properties online for potential rental by a renter or guest. Such property information can include, but is not limited to, an initial (or requested or suggested) price, availability, location, reviews and/or ratings about the property or owner, and the like, as understood by those of skill in the art. The initial price can be associated with a daily (or per night) fee or an overall fee. In some embodiments, the pricing for the systems and methods discussed herein may include a “per week,” “per month,” and the like parameter for renting the property. For purposes of this disclosure, the initial price will be discussed in relation to a per night fee, as is with conventional hotel and vacation rental booking systems; however, it should not be construed to limit the initial price terms to such, as embodiments exist where the price can be based upon a variety of factors, including, but not limited to, time of year, seasons, a renter's ratings, an owner's ratings, duration of stay, and the like.

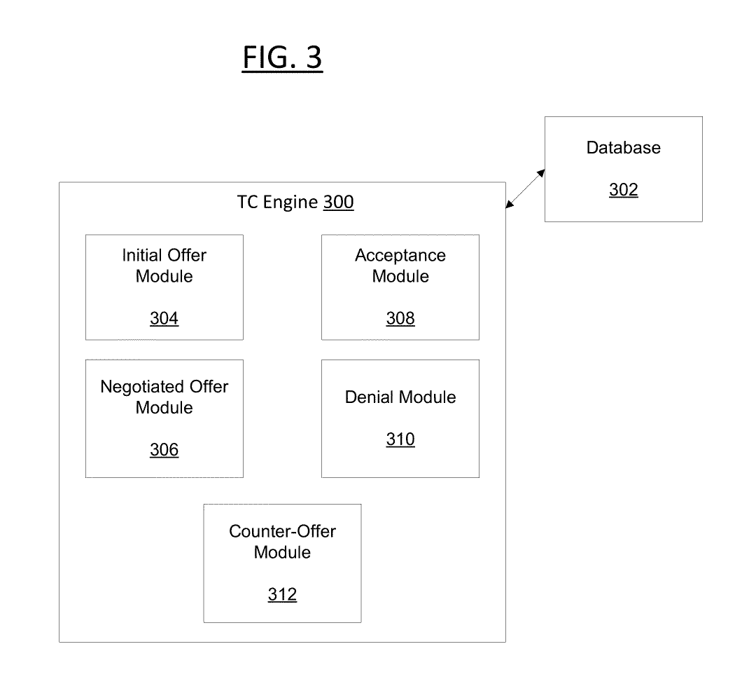

As discussed in more detail below, specifically in reference to FIGS. 3-5D, the present disclosure provides systems and methods for quickly completing an online transaction through a two-click transaction process occurring between an owner of a property and a renter. As discussed in more detail below, the transaction process can be implemented via a website, web page or a mobile application associated with a travel reservation booking platform. According to embodiments of the present disclosure, the two-click (TC) online transaction process disclosed herein is based upon an initial offer and a negotiated offer. The initial offer is based upon the initial listing of a property. For example, when an owner posts his/her property on a booking website, the property has an associated owner set fee. For example, when user Bob posts his lake house on the rental site GuestDoor®, in addition to the typical rental information associated with his property (e.g., location and availability, as discussed above), Bob sets an initial price term —$100/night. Therefore, for purposes of this disclosure, the initial offer comprises, inter alia, an initial price term (or price) set by the owner.

According to some embodiments, the initial price can also include additional information that is processed in accordance with the TC process. That is, an owner can set controlling information corresponding to other prices that he is willing to accept for the property. Such other prices can include a price range, a discounted percentage, or a “hard floor” denoting the absolute minimum the owner would be willing to entertain. For example, while Bob has set the price at $100/night, Bob may also indicate that he is willing to accept offers for a reduced price. For example, Bob may indicate that he is willing to entertain offers of the initial price term at a discounted rate of 20%, or any price between 75-100 dollars, or that he is unwilling to view any offer below 70 dollars.

According to some embodiments, the other price information associated with an initial price term may be set by the hosting website, e.g., GuestDoor®. That is, the hosting website may control the percentage of discount, or discount or absolute minimum per night a property could be reserved/booked for. Such controlling information can be site wide for all properties on a site, or property specific. For example, a hosting website may dictate that no property is allowed to be rented (or booked) at or below a threshold—for example, 20%. Therefore, for example, if property A is listed at $100/night and property B is listed at $200/night, then the lowest each property could be rented/booked for could be set at $80/night and $160/night, respectively. Indeed, the controlling information discussed above can be set by a combination of instructions set by the owner and system.

The TC process, as discussed above, also includes the negotiated offer. This offer can be based upon a renter interaction with the initial price on the website. That is, after a renter locates a property they wish to rent, the renter can make an offer to rent the property. Using the example above related to Bob's property, renter Jane locates Bob's lake house property and views that Bob's property is listed at $100/night. Jane, from this point, can submit an offer to Bob requesting a rental of this property. This rental request is the negotiated offer. The negotiated offer can include not only the number of days Jane requests to stay at the property, among other information associated with a rental, but also the price Jane desires to pay. The price can be the same price as set by Bob (e.g., the initial price), or can be a discounted price that Jane specifically requests.

For example, Jane, when selecting to make an offer, can be presented with a screen that shows the initial offer. Jane can set the number of days she desires to stay. Jane will have the ability to accept this initial price, whereby the negotiated offer that is sent to owner Bob will include the $100/night price. Jane also has the ability to submit a discounted price offer. That is, Jane can send a booking request to Bob that includes a different price from which Bob initially set. For example, Jane may submit a request to book the property which includes a price offer of $80/night.

According to preferred embodiments of the present disclosure, each offer submitted by Jane is a financially backed offer. That is, Jane's account must have included therein known or to be known financial institution payment information to fund any booking request. For example, Jane's offer can be backed by a credit card, debit card, Square® Cash, and the like. Thus, as discussed in more detail below, such, for example, credit card funded secure offers leads to reassured owners that renters are not simply “kicking the tires” of potential rental opportunities, but that they are submitting legitimate, financially funded requests that are booked upon acceptance. Indeed, each offer is a secure offer that can be encrypted by any known or to be known encryption algorithm or technology for securely transmitting identification and/or monetary information associated with a user, according to the standards of the applicable international standards of data privacy.

According to some embodiments, Jane's offer may also be required to be submitted in compliance with controlling information associated with the initial listing of the property. As discussed above, the initial price term of the property may have price controlling information associated therewith that limits level of reduction a renter may request. For example, if the lake house's $100/night property offer has an associated 20% maximum discount, whereby Bob is not allowed to entertain or receive an offer for less than 20%, and Jane submits a negotiation offer for $75/night, then Jane's negotiation offer may be immediately denied. That is, according to some embodiments, Jane may not be able to submit such an offer, and may be requested to resubmit an offer. Embodiments exist where such re-submitted can be limited to a threshold, where if a user submits requests below a discounted threshold a certain number of times (set by the owner or system as a whole, or some combination thereof), then Jane may be denied submitting further requests.

Thus, the TC process discussed herein now moves to the owner's acceptance or denial of the successfully submitted offer from the renter. The owner can accept the negotiated offer. That is, in response to receiving the negotiated offer from the renter, the owner can accept. Thus, in some embodiments, as a result of the owner's acceptance, the renter is automatically charged, as the offer was a secure and financially backed offer, as discussed above. In some embodiments, as discussed above, the funds can be placed in an escrow account associated with the owner and/or website (or third party), whereby after verification of the property, renter's credit and/or veracity involving the renters (or owner's) identity and/or the renter's intent to occupy the property (among other verifiable parameters), the funds can then be transferred after a predetermined period of time. For example, a renter can be booked for a property, and after 24 hours, the funds can then be transferred after an accounting is made regarding the owner and/or renter.

According to some embodiments, the acceptance may occur automatically in connection with preset controlling information. That is, an owner can set an instruction that if an offer is submitted in accordance with a predetermined range or at a value associated with a price or percentage of the initial price, then upon receiving an offer, the acceptance occurs automatically. For example, Bob may have set the initial price at $100/night, but indicated that he is willing to accept any offer at or above $90/night. Such indication may not be viewable to the renter (or visible on the website hosting the owner's property). As such, if Jane submitted a negotiation offer of $100/night (the same as the initial price term), then the acceptance of the offer is automatic upon Jane's submittal of her offer. In another example, if Jane's offer was for a price of $95/night, since this satisfies the $90/night or above threshold set by Bob, Jane's offer can be automatically approved, whereby Jane is immediately charged upon her request submission.

In embodiments where the owner does not accept the renter's offer, the owner has two options. The owner can affirmatively deny the offer, whereby the TC transaction is closed and the renter is not only alerted to such denial, but is also stopped from any further negotiations with the owner for such property for the initially requested time period. The owner can also counter-offer. In the counter-offer, the owner can submit a counter-offered price term to the renter, whereby the renter has two options: accept or decline. If the renter declines the counter offer, the negotiation is closed and the renter is stopped from any further negotiations with the owner for such property for the initially requested time period. However, if the renter accepts the counter-offer, the renter is automatically charged (his/her account is automatically charged).

According to some embodiments, the counter-offer communicated by the owner can be automatically triggered based upon preferences associated with the user's property, as set by the owner or system, or some combination thereof. That is, in response to receiving an offer that is below the initial price term, below a threshold price or within a specific range, an automated counter-offer may be triggered and communicated to the renter for his/her approval.

By way of a non-limiting example, continuing with the above example, Jane's bid of $75/night (from the initial $100/night) can be accepted or declined. If it is declined, either by Bob or by the system (as being below an accepted threshold for an offer), then the negotiation is closed, and Jane is not allowed to subsequently submit any offers for the lake house property for similar terms, such as, the same date range (e.g., check-in/check-out dates). If the Jane's bid is not accepted, but a counter-offer is communicated, Jane can either accept or decline. As discussed above, Bob can enter the counter-offer price, or the counter-offer price can be automatically determined and submitted in association with preferences associated with the user's property. For example, Bob can preset preferences/settings/instructions that if he receives at bid for his property at or below 25% the initial price quote/term, or below $20 off, then a counter-offer should be generated that comprises a price of a predetermined price, or a certain price above the requested price. For example, in response to Jane's $75/night bid, which is a 25% discount request, Bob's counter-offer preferences can automatically trigger a counter-offer of $80/night, which is sent to Jane.

Thus, as discussed above, upon Jane receiving the counter-offer, Jane can either accept or decline. If she declines, the negotiation is closed, at least for the same time period (e.g., number of days). If she accepts, then her account is automatically charged and she is booked for the room. Indeed, according to some embodiments, Jane's initial offer can have information associated with a differential amount from her negotiated offer that she is willing to accept. Such information can denote an amount of a price increase within a counter-offer that she will automatically accept. As such, if Bob's counter offer to Jane's $75/night offer increases the price $5/night to $80/night, and Jane has set this (either in her account preferences/settings or as a criteria in her initial negotiation request), then the counter-offer will be automatically accepted and her account automatically charged upon submittal of the counter-offer from the owner Bob.

As discussed above, preferences or settings associated with an owner and renter can be associated with, but not limited to, a price range the owner/renter is willing to accept in response to or accompanying an initial offer, negotiation offer and/or counter offer. The price range can be associated with a user's account (owner or renter's account) or specific to a particular property for which a negotiation has begun (e.g., an offer from renter/owner). The price range can be based upon a percentage discount or increase, or a price increase or decrease per night (or other time period for a renter renting a property).

According to some embodiments, the present disclosure focuses upon providing the TC transaction process in accordance with short-term, last-minute or temporary property rentals. Currently there is no marketplace for last-minute rentals. Indeed, there is no current system that employs direct negotiations for last-minute vacation rental bookings. Some conventional systems, such as, for example, OwnerDirect™ and Zaranga™, simply provide “last-minute” rentals by only temporarily displaying previously discounted properties. In fact, such systems lack any features or functionality for dynamically enabling a reduced price negotiation in real-time (or near-real time) between an owner and renter.

According to some embodiments, last-minute rentals can embody renter's submitting offers for rentals within 30 days of their stay for up to a predetermined threshold price (e.g., 40%, as discussed above). Thus, a guest (renter) is afforded the ability to securely book properties at a special price, while owners would receive income they would not have previously generated. That is, as the booking window narrows, renters typically turn to alternative accommodations that have more sophisticated last-minute options. This leads to fewer booking captures for the industry and contributes to a low average occupancy rate, which is half that of hotels. Indeed, vacation rentals in the US and EU, alone, rent an average of only 16 weeks a year, leaving a potential vacancy rate of 69%.

Therefore, according to some embodiments, by providing a complimentary last-minute marketplace strategy to the standard pricing approach of industry leaders, the disclosed systems and methods enable owners the ability to utilize both models (standard pricing and TC modeling pricing) at various times in the rental lifecycle to increase occupancy and maximize revenue. Deep discount and standard pricing models do not easily coexist in one marketplace, as owners want to avoid prematurely compromising their rate with promotions for deeper discounts. Limiting bookings and negotiated pricing to a strict time window (e.g., 30-day window), allows owners to capture their market rates and provide discounts only as their booking window closes. Thus, the present disclosure can provide an efficient booking process that channels funded requests through a narrow booking window for negotiated transactions. A narrowed booking window can encourage owners to offer higher discounts, while incentivizing renters to book with a particular service for last-minute deals.

However, the present disclosure should not be construed to limit the current scope an applicability of the TC transaction process (and “make offer” algorithm) discussed herein to only last-minute or short-term rentals, as the applicability of the disclosed transaction process can be embodied in any known or to be known methodology for negotiating terms of a deal. For example, the systems and methods discussed herein can be applied to negotiating, in addition to rentals, sales, trades, salaries, labor prices, or any other type of negotiation process for property or services. Indeed, while the terms discussed here are in connection with price, it should not be construed to limit the TC process solely to price, as any type or form of quantitative data (e.g., date ranges and the like) associated with a deal can be negotiated in a similar manner, as evidenced from the present disclosure

Furthermore, while the present disclosure centers around vacation rental properties, it should be understood that the focus of the two-click transaction process is not limited to rental properties, as discussed herein, in that properties can include, but are not limited to, homes, apartments, timeshares, hotels, bed and breakfasts, motor homes, cars, motorcycles and other types of vehicles, boats, and the like.

According to some embodiments, the systems and methods disclosed herein can leverage the information associated with the TC process for advertising purposes. That is, the present disclosure enables the determination of geographical and demographic information from a negotiation process on a website (e.g., GuestDoor®) for monetization purposes, where targeted advertisements can be served based upon the data of a vacation rental booking. For example, if Bob's lake house is located in Austin, Tex., and Jane is from Boston, Mass., the disclosed systems and methods may realize that Jane should be served advertisements for local restaurants in Austin, Tex. (or other activities) due to her impending stay in Austin, Tex.

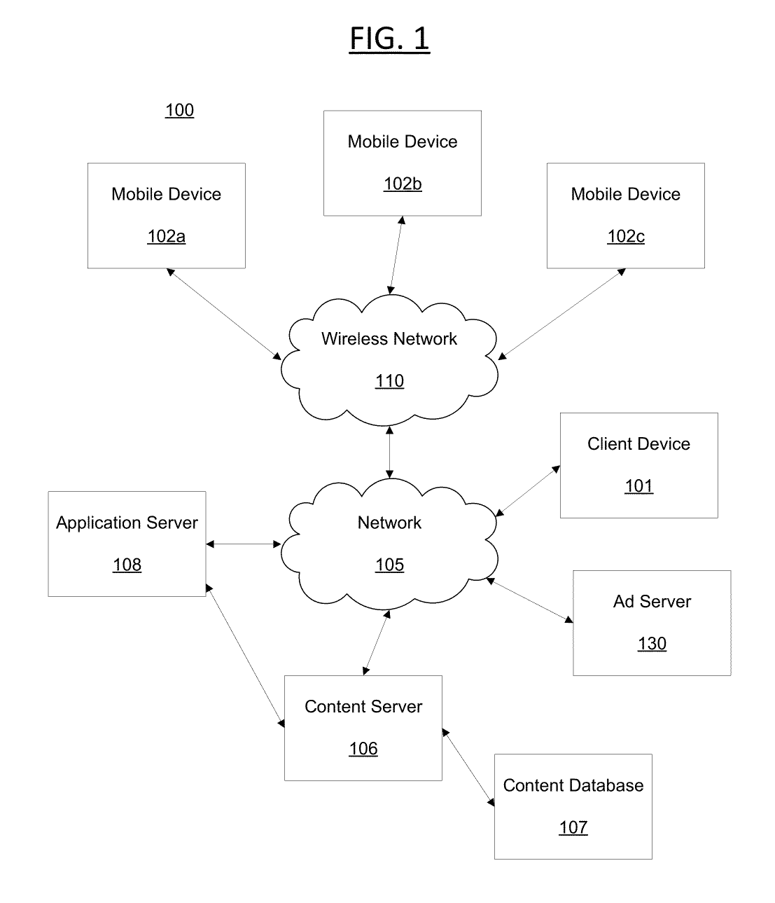

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components (or order of steps) may be made without departing from the spirit or scope of the disclosure.

As shown, system 100 of FIG. 1 includes local area networks (“LANs”)/wide area networks (“WANs”)—network 105, wireless network 110, mobile devices (client devices) 102a-102c and client device 101. FIG. 1 additionally includes a variety of servers, such as content server 106, application (or “App”) server 108 and advertising (“ad”) server 130.

One embodiment of mobile devices 102a-103 is described in more detail below. Generally, however, mobile devices 102a-102c may include virtually any portable computing device capable of receiving and sending a message over a network, such as network 105, wireless network 110, or the like.

Mobile devices 102a-102c may also be described generally as client devices that are configured to be portable. Thus, mobile devices 102a-102c may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102a-102c typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102a-102c also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102a-102c may uniquely identify themselves through any of a variety of mechanisms, including a phone number, Mobile Identification Number (MIN), an electronic serial number (ESN), or other mobile device identifier.

In some embodiments, mobile devices 102a-102c may also communicate with non-mobile client devices, such as client device 101, or the like. In one embodiment, such communications may include sending and/or receiving messages, share photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-102c computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102a-102c and its components with network 105. Wireless network 110 may include any of a variety of wireless sub-networks that may further overlay stand-alone ad-hoc networks, and the like, to provide an infrastructure-oriented connection for mobile devices 102a-102c. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly. Wireless network 110 may further employ a plurality of access technologies including 2nd (2G), 3rd (3G), and/or 4th (4G) generation radio access for cellular systems, WLAN, Wireless Router (WR) mesh, and the like. Access technologies such as 2G, 3G, 4G and future access networks may enable wide area coverage for mobile devices, such as mobile devices 102a-102c with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device s 102a-102c and another computing device, network, and the like.

Network 105 is configured to couple content server 106, application server 108, or the like, with other computing devices, including, client device 101, and through wireless network 110 to mobile devices 102a-102c. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between content servers 106, application server 108, client device 101, other content or information available on or via the network 103, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within a social networking site. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server106 may include a device that includes a configuration to provide content via a network to another device. A content server 106 may, for example, host a site, such as a vacation rental site, social networking site, or a personal user site (such as a blog, vlog, and the like). A content server 106 may also host a variety of other sites, including, but not limited to business sites, educational sites, dictionary sites, encyclopedia sites, wikis, financial sites, government sites, and the like. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, email services, photo services, web services, third-party services, audio services, video services, instant messaging (IM) services, SMS services, MMS services, FTP services, voice over IP (VOIP) services, or the like. Such services, for example the property rental services, can be provided via content server 106. Examples of content may include images, text, audio, video, or the like, which may be processed in the form of physical signals, such as electrical signals, for example, or may be stored in memory, as physical states, for example.

An ad server 130 comprises a server or ad platform that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” or ad platforms may associate advertisers or publishers, such as via a platform to facilitate buying or selling of online advertisement inventory from multiple ad networks. “Ad networks” refers to aggregation of ad space supply from publishers, such as for provision en masse to advertisers. For web portals advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108 and 130 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In an embodiment, users are able to access services provided by servers 106, 108 and/or 130. This may include in a non-limiting example, email servers, social networking services servers, SMS servers, IM servers, MMS servers, exchange servers, and all other known or to be known types of messaging servers, in addition to, travel services servers (as discussed herein), via the network 105 using their various devices 101-102c. In some embodiments, applications, such travel service applications (e.g., mobile applications for vacation rentals, for example), can be hosted by the application server 108. Thus, the application server 108 can store various types of applications and application related information including application data and user profile information. In another example, content server 106 can host vacation rental applications; therefore, the content server 106 can store various types of applications and application related information including property data and user profile information. It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein.

Moreover, although FIG. 1 illustrates servers 106, 108 and 130 as single computing devices, respectively, the disclosure is not so limited. For example, one or more functions of servers 106, 108 and/or 130 may be distributed across one or more distinct computing devices. Moreover, in one embodiment, servers 106, 108 and/or 130 may be integrated into a single computing device, without departing from the scope of the present disclosure.

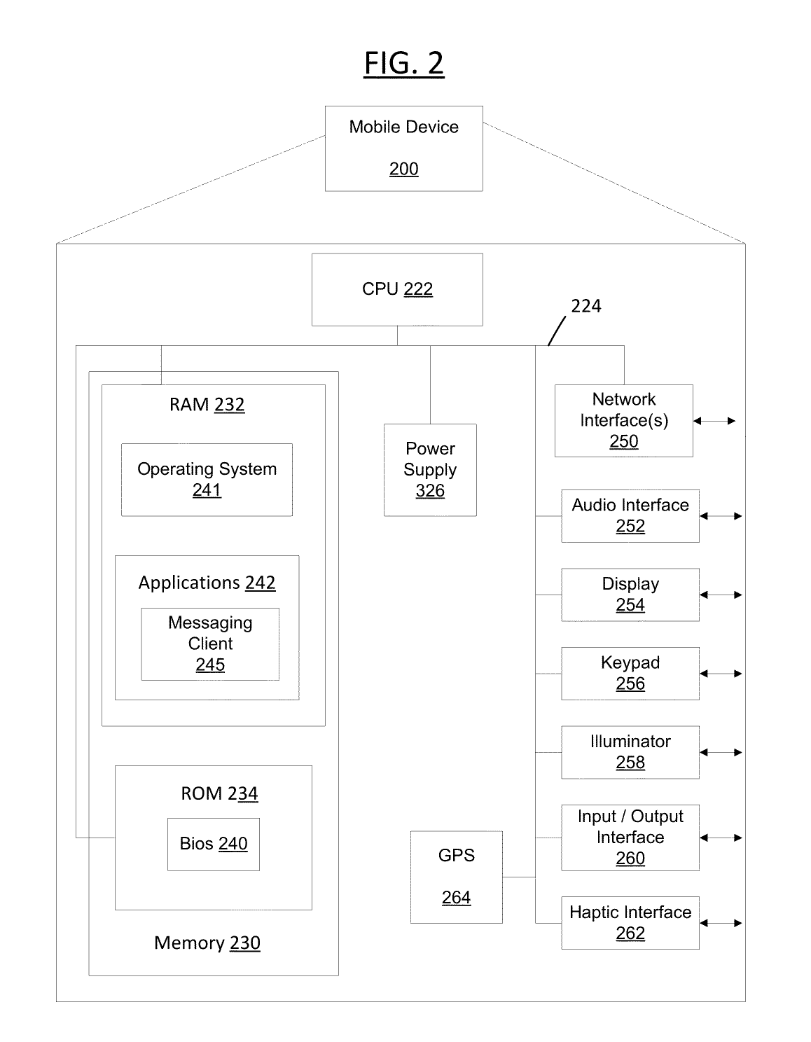

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within a client device.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using SMS, MMS, IM, email, VOIP, and/or any of a variety of other messaging communication protocols. Although a single messaging client 245 is illustrated it should be clear that multiple messaging clients may be employed. For example, one messaging client may be configured to manage SMS messages, where another messaging client manages IM messages, and yet another messaging client is configured to manage serving advertisements, emails, or the like.

Having described the components of the general architecture employed within the disclosed systems and methods, the components' general operation with respect to the disclosed systems and methods will now be described.

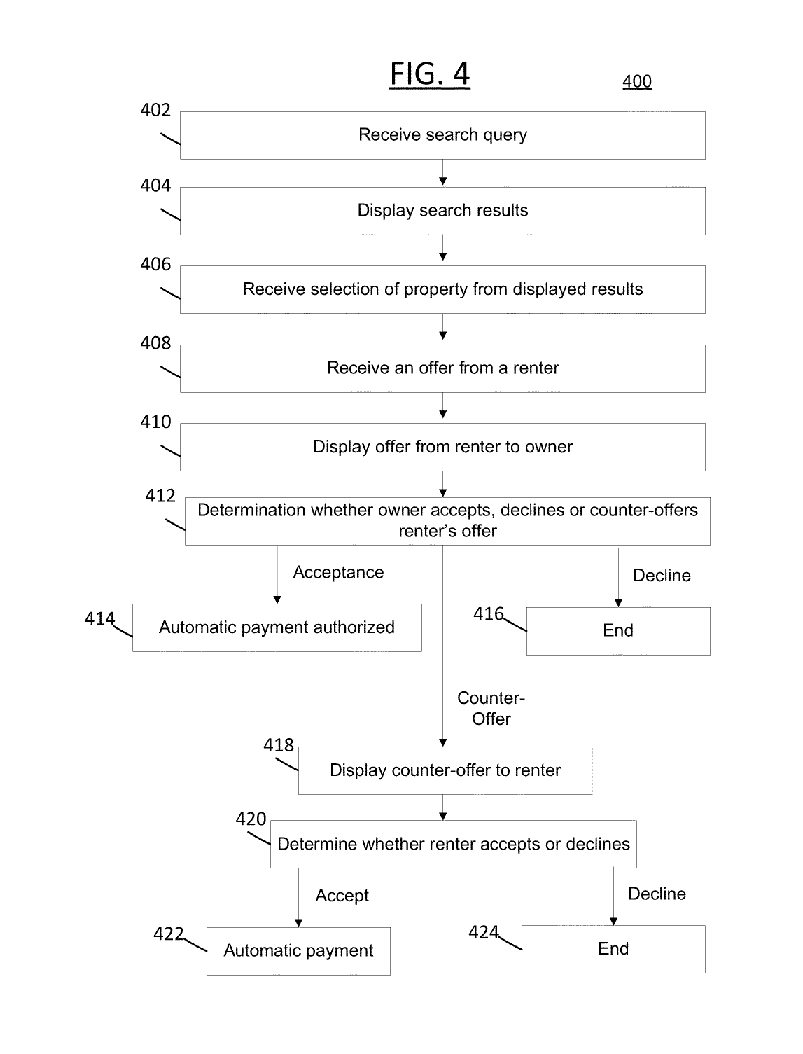

FIG. 3 is a block diagram illustrating the components of system for performing the systems and methods discussed herein. FIG. 3 includes a TC engine (or offer engine) 300 and a database 302 for storing information associated with a vacation rental service. As discussed herein, such information can include, but is not limited to, property data/information associated with a property, user profile information (including demographic information, geographical information and the like), and the like. The TC engine 300 could be hosted by a web server, application server, content provider, vacation rental service provider, ad server, a user's computing device, or any combination thereof. Indeed, the steps performed by the TC engine 300, as discussed below in FIG. 4, can be performed by an application running on a computing device (such as a web-browser displaying a webpage or installed application specific to a website or service provider), or via a web-based application. The information can be accessed, retrieved, downloaded, uploaded, monitored, processed and provided to the TC engine 300 or accessed by a computer program or device that can access such information. In some embodiments, the information provided to and processed by the TC engine 300 can be stored in a database 302, which is associated with vacation rental provider/service, such as GuestDoor®. The database 302 can be any type of database or memory that can store the information, property data, user data, bids/offers (e.g., initial bids/offers, negotiated bids/offers, counter-offers) and associated offer information, acceptance information and denial information, as discussed herein.

As discussed above, with reference to FIG. 1, the network 304 can be any type of network such as, but not limited to, a wireless network, a local area network (LAN), wide area network (WAN), the Internet, or a combination thereof. The network 304 facilitates connectivity between the user devices and the content server 106 or application server 108, the TC engine 300, and the database of stored resources 302.

The TC engine 300 includes an initial offer module 304, a negotiated offer module 306, an acceptance module 308, a denial module 310 and a counter-offer module 312. It should be understood that the engine(s) and modules discussed herein are non-exhaustive, as additional or fewer engines and/or modules, or sub-engines or sub-modules may be applicable to the embodiments of the systems and methods discussed. The operations, configurations and functionalities of each module, and their role within embodiments of the present disclosure will be discussed with reference to FIG. 4, whereby the components of system 300 are implemented to perform the steps of process 400.

FIG. 4 is a process 400 diagram illustrating steps performed in accordance with embodiments of the present disclosure. As discussed above, the present disclosure involves systems and methods for a two-click (TC) transaction process on a vacation rental website (platform) occurring between an owner of a property and a renter.

Process 400 begins with Step 402 where a renter enters a search request for a vacation property. In some embodiments, the search request can be associated with a location, and in some embodiments, the search request can be for properties having specific attributes or being of a particular type. For example, the renter can enter a search for properties with a pool. For purposes of this discussion, the search will be based upon a location entered by a renter; however, this should not be construed as limiting, as Process 400 is similarly applied to other search terms as understood by those of skill in the art.

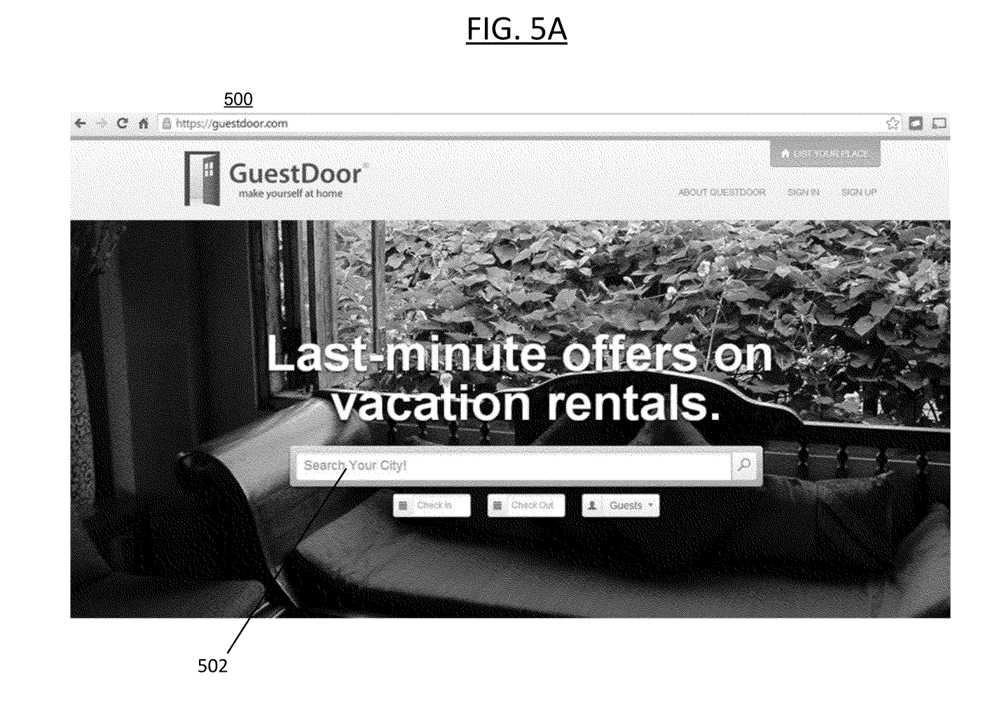

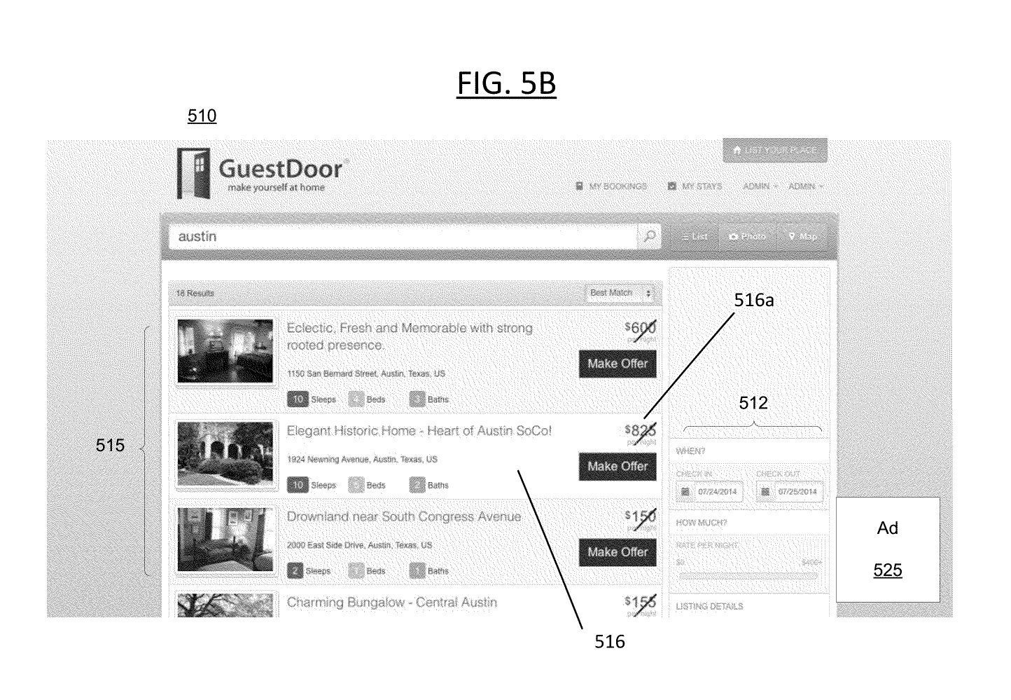

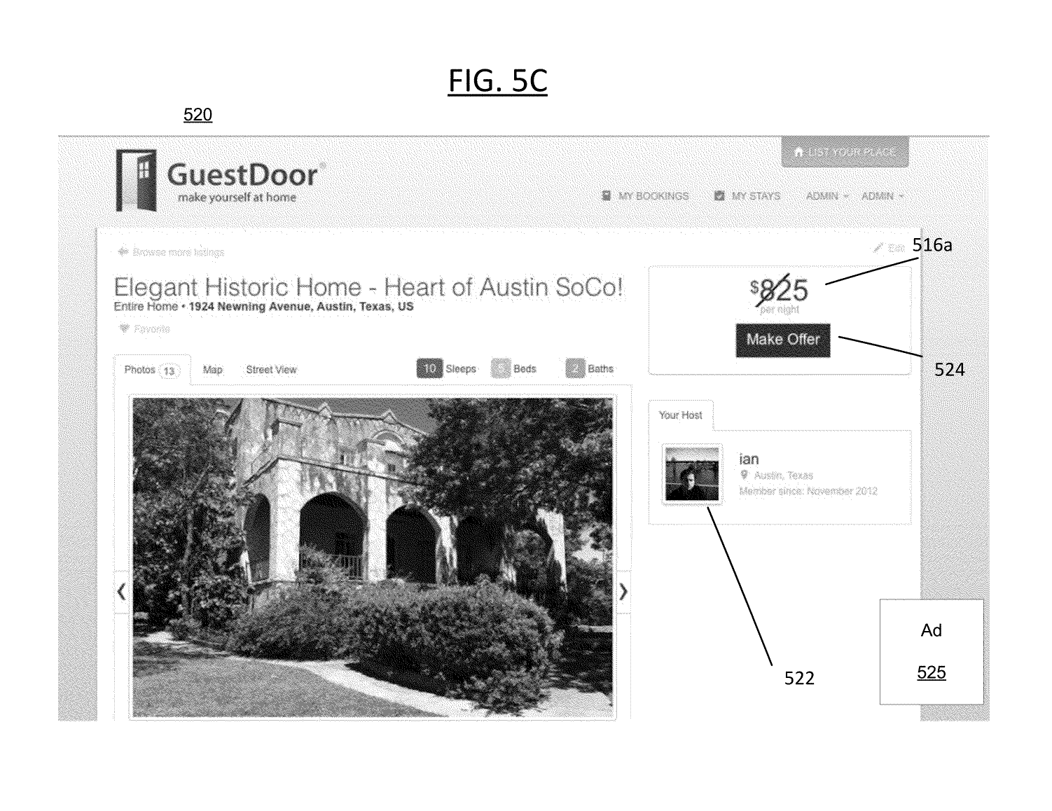

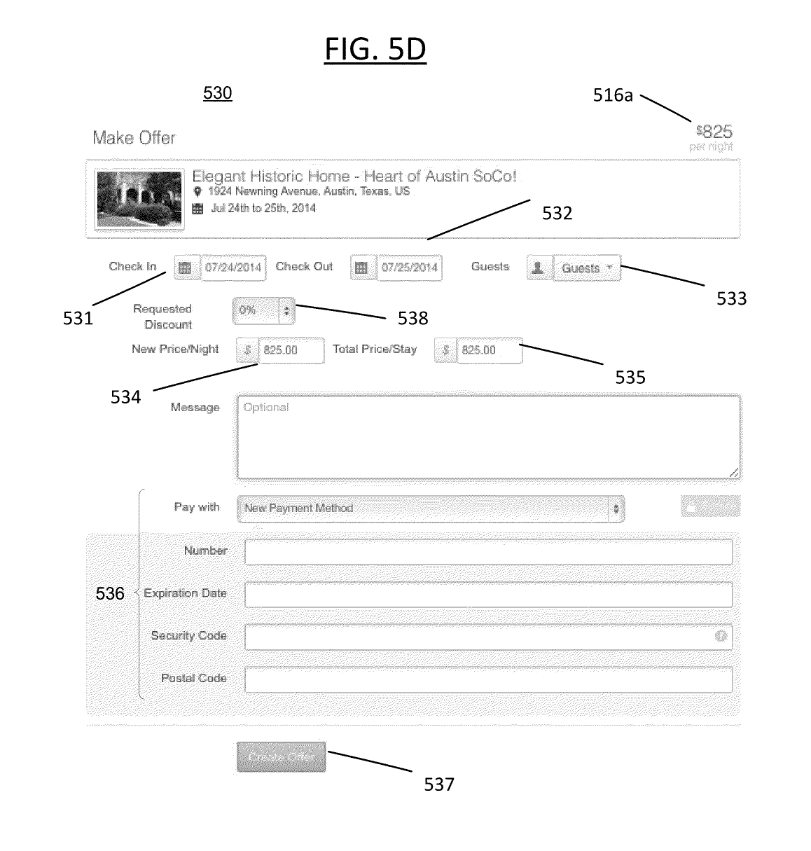

As illustrated in FIG. 5A, screen 500 shows a homepage of an example site where a renter can enter a search for properties in, for example, Austin, Tex. For purposes of the discussion of Process 400, the steps discussed herein will be associated with the example discussed herein, such that non-limiting example embodiments illustrated in FIGS. 5A-5D will be utilized to clearly illustrate the steps of Process 400. Thus, for example, the search is entered in item 502.

In Step 404, a search is performed based on the search query and search results are displayed. The displayed result can be seen in screen 510 in FIG. 5B, where the listing 515 illustrates those properties that are associated with the renter's search request. As discussed in more detail below, an advertisement, ad 525 can be displayed on the search results based on renter data/information associated with the renter and/or the search request.

As illustrated in screen 510, each listing comprises listing information providing details of each property and an initial price. As discussed above, a displayed price is the initial price term associated with a listing. For example, the individual listing 516 having title “Elegant Historic Home—Heart of Austin SoCo!” has an initial price term of “$825 per night”, denoted as item 516a. Such price term can be set by the owner of the property, as discussed above. According to some embodiments, the line through the price in item 516a denotes that the price is negotiable, and/or is a short-term/last-minute rental.

According to some embodiments, in connection with item 512 (e.g., menu) the renter can also input further information related to how long they desire to stay a location, and submit a request for a reduced price, as discussed in more detail below. That is, as discussed in more detail below, the renter can initiate a negotiation offer from the listing screen of page 510. Menu item 512 allows a renter to enter a check-in date, a check-out date, and an indication of how much the renter desire's to pay for the property. Functionality of item 512 is similar to the “Make Offer” page 530 illustrated in FIG. 5D, and will be discussed therein accordingly. According to some embodiments, item 512 can be displayed respective all of the listings in listing 515, or only highlighted upon renter input in connection with a specific listing—for example, in FIG. 5B, item/menu 512 is illustrated adjacent to listing 516 in response to a renter either initially selecting listing 516 or holding his/her mouse (or other type of input) over the listing, as understood by those of skill in the art.

According to some embodiments, the listing 515 (i.e., search results) can be based on a time period determination. That is, for example, a website can have the ability to providing only search results for a predetermined period of time from the time a renter enters his/her search (e.g., based on temporal data associated with a search request in Step 402). As discussed above, such site can be a last-minute rental site, such as GuestDoor®. The period of time can be set by a site administrator, owner, agent and the like, or some combination thereof. For example, if GuestDoor® is enabling renters to search for last-minute properties for up to and including 30 days, the search results will only display properties that are available for 30 days from the time the search was entered. Any property that is available and is relevant to the search query that is within that time period can be displayed, while relevant properties that are available outside that time period may not be displayed.

By way of a non-limiting example, on September 1^{st} Angela submits a search for properties in “Austin, Tex.” on the site: GuestDoor®. The site is specific for providing last-minute rentals only for 30 days; therefore, the search results displayed to Angela will only be for properties that are available within 30 days from her initial request—i.e., September 1 to September 30. Properties that become available on October 1 will not be displayed because this does not satisfy the time period be applied by the hosting site. Therefore, for example, Step 404 may involve, according to some embodiments, displaying search results based on the renter's search query in accordance with a time period, as discussed above.

It should be understood by those of skill in the art that embodiments exist where the time period will be applied, and embodiments exist where the time period may not be applied. That is, in some embodiments, a hosting site may be time-period specific, thereby filtering out properties that are not within a site-set (preset) period, and in some embodiments, no time period may be applied. Some embodiments exist where the time period can be based on external data, such as a date input by the user upon requesting a check-in date.

In Step 406, a renter makes a selection of a listed property amongst listing 515. As a result of this, the renter is presented with the listing page 520. Page 520 shows the details of each listing—specifically selected listing 515. Such information, as illustrated in FIG. 5C, can include, but is not limited to, information about the owner of the property 522, the initial price 516a of the listing and the like. As discussed above and in more detail below, the page 520 can also provide an advertisement 525 associated with businesses or entities associated with or related to the location of the property displayed on the page 520. Page520 also includes a “Make Offer” button 524 that enables the TC process discussed herein.

That is, in Step 408, a renter selects the “Make Offer” button 524, which can take the renter to “Make Offer” page 530. This can be performed by the initial offer module 304. In some embodiments, as understood by those of skill in the art, similar functionality can be effectuated by inputting the same information in item 512 on page 510, as discussed above. Page 530 enables a renter to enter a check-in day (item 531), a check out day (item 532), the number of guests (item 533), among other information such as a message (to the owner). It should be understood that any other type of information for booking a rental property could be included on page 530.

Page 530 displays the initial price term set by the owner: $825/night—item 516a, as discussed above. Page 530 further includes an area 534 for a renter to enter a negotiated price (or bid price). According to some embodiments, area 534 is a text/digit entry area; however, such area can be a scroll bar where a renter can effectively move an indicator on the bar to a price within a predefined range (where the range is an allowed range of applicable prices the Owner will and/or can entertain, as discussed above). Page 530 also includes, according to some embodiments, a “Total Price/Stay” area 535. This area can be populated as a direct result from the renter entering check-in/out information and a price per night information in items 531, 532 and 534 respectively. In some embodiments, the renter can enter the total price per stay in item 535, whereby the price per night item 534 will then be populated accordingly. In some embodiments, in connection with item 538, a renter can adjust the price term (e.g., overall cost, or cost per night) by a percentage. As discussed herein, the adjusted percentage can be in accordance with a limit set by the site (e.g., GuestDoor®) or by the owner of a property, or some combination thereof. Page 530 also includes item 536, which is the area a renter enters his/her payment information. As discussed above, such payment information is required as the negotiation offer (or bid) is financially backed offer. Thus, for example, item 536 may require the renter to enter his/her credit card (and billing) information. According to some embodiments, item 536 may not be displayed, may not be required to be filled out, or may be auto-populated in instances where the renter has financial payment information associated with the renter's account (or renter profile), or pulled from the user's browser or other application running on the renter's device. The “create offer” button 537 is used to submit the offer put together on page 530. As discussed below, this submittal is transmitted over the hosting site to the owner for further negotiation.

At this point, the TC process begins, as reflected in the discussion below with respect to Steps 408-424. As discussed above the TC process involves the negotiation between an owner and renter on a site (e.g., GuestDoor®), whereby a deal is either achieved or the negotiation concludes without one occurring. Such process will be detailed followed by a non-limiting example which illustrates and clarifies the discussed steps of Process 400.

In Step 408, a renter can make an offer on a selected search result. This step is performed by the negotiated offer module 306. As discussed above, the offer can be the same as the initial price or a reduced price from the initial price. In Step 410, the renter's offer is then communicated to the owner via the hosting site. That is, the renter's offer is displayed to the owner, either upon the owner opening a message sent to the owner from the site, or upon the owner logging into the website. In Step 412, a determination is made regarding whether the owner accepts, declines or counter-offers the renter's offer. As discussed above, such determination may be made automatically based upon preset preferences set by the owner, or such determination may be based upon input from the owner in response to the displayed renter offer.

If the owner accepts the renter's offer, then the deal is finalized by automatically charging the renter's account (as per the payment information entered in item 536, for example). Step 414. This is performed by the acceptance module 308. If the owner declines the renter's offer, then no deal is deemed reached, and the process 400 ends. Step 416. This is performed by the denial module 310. If the owner counter offers, the process 400 continues to Step 418, where the counter-offer is communicated to the renter. Steps 418-424 are performed by the counter-offer module 312. That is, the counter-offer from the owner in response to the renter's offer will be displayed to the renter. Such display, as with the display of the renter's offer as discussed above, can be effectuated via a message sent to the renter, or upon the renter logging into the site.

It should be understood that the message displays in Steps 410 and 418 can be effectuated via communications of any type of known or to be known message, either via the website platform or an associated platform, such as, but not limited to, email messages, IMs services, SMS/MMS messages, social networking messages, and the like.

In Step 420 a determination is made regarding whether the renter accepts or declines the owner's counter-offer. As discussed above, such determination may be made automatically based upon preset preferences set by the renter, or such determination may be based upon input from the renter in response to the displayed owner counter-offer. If the renter accepts the owner's counter-offer, then the deal is finalized by automatically charging the renter's account (as per the payment information entered in item 536, for example). Step 422. If the renter declines the counter-offer, then no deal is reached, and the process 400 ends. Step 424.

According to some embodiments, Process 400 may not be limited to a single offer and/or counter-offer. That is, Process 400 can include after the process beginning again after the owner declines (Step 416) and/or the renter declines the counter offer (Step 424) thereby enabling further negotiation between the owner and renter. The number of iterations in Process 400 can be limited by the owner, renter, a third party and/or website, according to preferences set by any party to the process, and/or some combination thereof.

By way of another non-limiting example, owner Jack posts his Vermont ski lodge on a vacation booking site. Jack lists his property at $200/night. Additionally, Jack may indicate that he is only willing to take offers for a 50% reduced price (or $100/night). (As discussed above, the booking site may have this setting independent any indication from Jack). Renter Jill performs a search for properties in Vermont on Nov. 1, 2014. Since the booking site is, for example, only for last-minute rentals of 30 days, Jill will be presented with search results displaying available rentals for the month of November (i.e., November 1-30). Jill can select a search result, review the information for the rental and submit an offer, which must be accompanied by payment information. For example, Jill selects Jack's listing and sees that the lodge is listed at $200/night. Jill enters an offer for $50/night. For example, she can enter this by entering the specific price (via item 534) or by putting in a reduced price request of 75% the offer (via item 538). Since this is below the $100/night or 50% limit set by Jack (or the site), this will not be able to be entered. In order to enter an offer, Jill will have to enter a price that satisfies the predetermined threshold set for Jack's listing.

In some embodiments, denial of an initial offer for not satisfying such threshold may be indicated to Jill through message, or display page or dialog box on the website display, and in some embodiments, this may lead to Jill being stopped from actually entering another offer.

Jill, having another chance to enter an offer, enters a price of $100/night (or 50% discount). This offer is then communicated to Jack via the booking site. Jack reviews the offer, and can either accept, decline or counter-offer. If Jack declines, there is no deal and the negotiation is stopped. If Jack accepts, Jill's account (e.g., her payment information) is automatically charged. If Jack counter-offers, he submits a different offer back to Jill for her review. For example, Jill's offer was for $50/night. Jack counters with $150/night, which is sent to Jill for her review. Jill can either accept or decline. If Jill declines, the negotiation ends. If Jill accepts, her account is automatically charged.

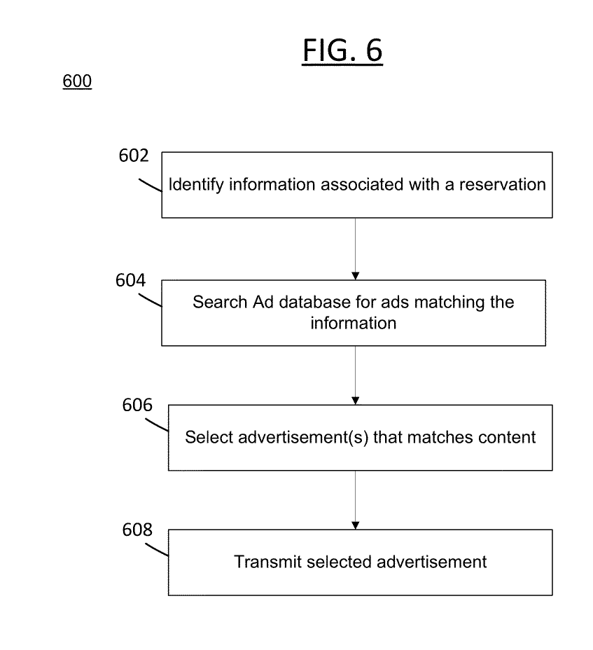

FIG. 6 is a work flow illustrating a process 600 for serving relevant advertisements based on a reservation (or search for property). Specifically, FIG. 6 illustrates how advertisements are served to renters based on reservation requests, negotiations of the reservation and confirmation of reservations. In Step 602, information associated with a reservation request is identified. That is, user data (of the renter) associated with reservation request is compiled, and this information, forms a basis for a context for serving advertisements having a similar context. For example, the information can be related to the content submitted in a request for a listing of available rentals at a location. For example, as illustrated in FIG. 5A, a renter enters a request for a listing of places in Austin, Tex., and as a result, as illustrated in FIG. 5B, the renter is displayed results associated with listings in Austin, Tex. Thus, an advertisement 525 can be based on, for example, restaurants, or other businesses or entities located in Austin, Tex. In another example, the information can be related to demographic data associated with the renter derived from the renter's profile with the hosting website, e.g., GuestDoor®. Thus, for example, if the renter is a 21 year old male, an ad 525 may be displayed on the listing page 510 related to bars and other nightlife. In some embodiments, an advertisements, ad 525, may include sponsored content associated with a preferred listing (as purchased by an owner of a listing), such that a lowered price or incentives may be given to the user for selecting and booking such listing.

In Step 604, the information (or data) is communicated (or shared) from the rental platform to an ad platform, which can include an advertisement server 130 and an associated advertisement database. Upon receipt of the information, the advertisement server 130 performs a search for a relevant advertisement within the associated advertisement database. The search for an advertisement is based at least on the identified content.

In Step 604, the advertisement server 130 searches the advertisement database for advertisements that relate to (or match) the identified content. In Step 606, an advertisement(s) is selected (or retrieved) based on the results of Step 604. In some embodiments, the advertisement(s) can be selected based upon the result of Step 604, and modified to conform to attributes of the page upon which the advertisement will be displayed, and/or to the operating system or device for which it will be displayed. In some embodiments, as in Step 608, the selected advertisement(s) is shared or communicated via the hosting site platform. In some alternative embodiments, the selected advertisement is sent directly to each user's computing device. As such, as illustrated in FIGS. 5B-5C, the transmitted advertisement, advertisement 525, can be displayed in connection with a page the renter is viewing.

By way of a non-limiting example, continuing with the above example between owner Jack and renter Jill, upon Jill viewing search results for properties in Vermont, Jill can be presented with an advertisement displayed on the search results page. The advertisement may be related to ski rental locations or sponsored properties being hosted by the site.

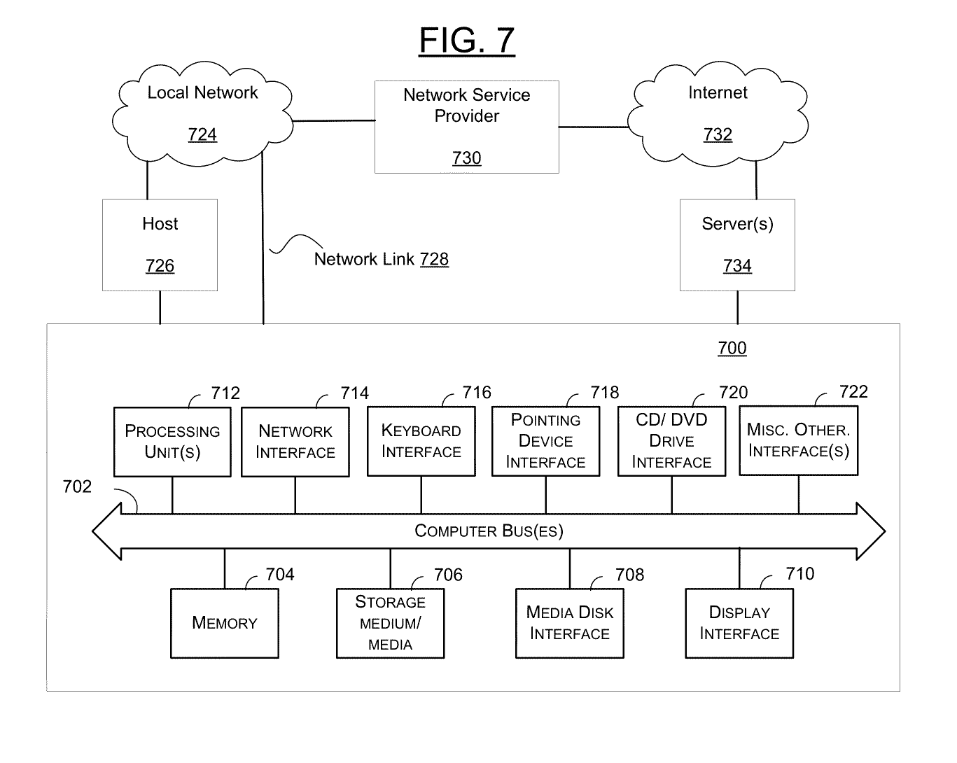

As shown in FIG. 7, internal architecture 600 includes one or more processing units, processors, or processing cores, (also referred to herein as CPUs) 712, which interface with at least one computer bus 702. Also interfacing with computer bus 702 are computer-readable medium, or media, 706, network interface 714, memory 704, e.g., random access memory (RAM), run-time transient memory, read only memory (ROM), media disk drive interface 720 as an interface for a drive that can read and/or write to media including removable media such as floppy, CD-ROM, DVD, media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces and a universal serial bus (USB) interface.

Memory 704 interfaces with computer bus 702 so as to provide information stored in memory 704 to CPU 712 during execution of software programs such as an operating system, application programs, device drivers, and software modules that comprise program code, and/or computer executable process steps, incorporating functionality described herein, e.g., one or more of process flows described herein. CPU 712 first loads computer executable process steps from storage, e.g., memory 704, computer readable storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage, e.g., medium/media 706, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 728 typically provides information communication using transmission media through one or more networks to other devices that use or process the information. For example, network link 728 may provide a connection through local network 724 to a host computer 726 or to equipment operated by a Network or Internet Service Provider (ISP) 730. ISP equipment in turn provides data communication services through the public, worldwide packet-switching communication network of networks now commonly referred to as the Internet 732.

A computer called a server host 734 connected to the Internet 732 hosts a process that provides a service in response to information received over the Internet 732. For example, server host 734 hosts a process that provides information representing video data for presentation at display 710. It is contemplated that the components of system 700 can be deployed in various configurations within other computer systems, e.g., host and server.

At least some embodiments of the present disclosure are related to the use of computer system 700 for implementing some or all of the techniques described herein. According to one embodiment, those techniques are performed by computer system 700 in response to processing unit 712 executing one or more sequences of one or more processor instructions contained in memory 704. Such instructions, also called computer instructions, software and program code, may be read into memory 704 from another computer-readable medium 706 such as storage device or network link. Execution of the sequences of instructions contained in memory 704 causes processing unit 712 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 700. Computer system 700 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 702 as it is received, or may be stored in memory 704 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” “customer” or “renter” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, at a computing device over a network, a search request from a user for available property rentals;
searching, via the computing device, for a listing of properties based on said search request, said listing comprising property information associated with each property, said property information comprising an initial price set by an owner of each property;
causing, via the computing device, said listing of properties to be communicated to said user;
receiving, at the computing device, a user offer to reserve a first property of said listing, said user offer comprising a price request below the initial price from the user and payment information associated with an account of said user;
determining, via the computing device, a status of said user offer, said status based upon an acceptance, denial or counter-offer from an owner of said first property, said counter-offer comprising a second price set by the first owner in response to said user price request;
automatically charging, via the computing device, said account and reserving said first property for said user upon said status indicating said acceptance of said user offer;
stopping, via the computing device, further communication between said user and first owner for said first property upon said status indicating said denial of said user offer; and
communicating, over the network, said counter-offer to said user upon said status indicating said counter-offer.

2. The method of claim 1, further comprising:
determining a status of said counter-offer, said counter-offer status based upon an acceptance or denial from said user.

3. The method of claim 2, further comprising:
automatically charging said account and reserving said first property for said user upon said counter-offer status indicating said acceptance of said counter-offer; and
stopping further communication between said user and first owner for first property upon said counter-offer status indicating said denial of said counter-offer.

4. The method of claim 2, wherein said counter-offer status is automatically determined based upon settings predefined by the user.

5. The method of claim 1, wherein said user offer and said counter-offer are communicated through a property rental website, wherein said computing device hosts said property rental website.

6. The method of claim 1, wherein said property information further comprises information describing each property, wherein said property information is stored in storage associated with a property rental website.

7. The method of claim 1, wherein said listing comprises properties available for a predetermined period of time, said period of time corresponding to a booking window for said first property based upon temporal data associated with said search request.

8. The method of claim 1, wherein said user offer further comprises a check-in date and a check-out date.

9. The method of claim 1, wherein said status is automatically determined based upon settings predefined by said first owner.

10. The method of claim 1, wherein said status determination comprises:
communicating said user offer to said first owner; and
receiving a determination from said first owner, said determination providing an indication regarding said acceptance, denial or counter-offer of said user offer.

11. The method of claim 10, wherein said acceptance comprises an indication from that said first owner accepts the user's price request, wherein said denial comprises an indication that said first owner declines to accept said price request.

12. The method of claim 1, wherein said user offer is available for first owner review for a predetermined period of time.

13. The method of claim 1, wherein said counter-offer is available for user review for a predetermined period of time.

14. The method of claim 1, wherein said user price request comprises a price within a predetermined range of said initial price.

15. A non-transitory computer-readable storage medium tangibly encoded with computer-executable instructions, that when executed by a processor associated with a computing device, performs a method comprising:
receiving, over a network, a search request from a user for available property rentals;
searching for a listing of properties based on said search request, said listing comprising property information associated with each property, said property information comprising an initial price set by an owner of each property and information describing each property;
causing said listing of properties to be communicated to said user;
receiving a user offer to reserve a first property of said listing, said user offer comprising a price request below the initial price from the user and payment information associated with an account of said user;
determining a status of said user offer, said status based upon an acceptance, denial or counter-offer from an owner of said first property, said counter-offer comprising a second price set by the first owner in response to said user price request;
automatically charging said account and reserving said first property for said user upon said status indicating said acceptance of said user offer;
stopping further communication between said user and first owner for said first property upon said status indicating said denial of said user offer; and
communicating, over the network, said counter-offer to said user upon said status indicating said counter-offer.

16. The non-transitory computer-readable storage medium of claim 15, further comprising:
determining a status of said counter-offer, said counter-offer status based upon an acceptance or denial from said user;
automatically charging said account and reserving said first property for said user upon said counter-offer status indicating said acceptance of said counter-offer; and
stopping further communication between said user and first owner for first property upon said counter-offer status indicating said denial of said counter-offer.

17. The non-transitory computer-readable storage medium of claim 15, wherein said listing comprises properties available for a predetermined period of time, said period of time corresponding to a booking window for said first property based upon temporal data associated with said search request.

18. The non-transitory computer-readable storage medium of claim 15, wherein said status determination comprises:
communicating said user offer to said first owner; and
receiving a determination from said first owner, said determination providing an indication regarding said acceptance, denial or counter-offer of said user offer, wherein said acceptance comprises an indication from that said first owner accepts the user's price request, wherein said denial comprises an indication that said first owner declines to accept said price request.

19. A system comprising:
at least one computing device comprising:
memory storing computer-executable instructions; and
one or more processors for executing said computer-executable instructions, comprising:
receiving, over a network, a search request from a user for available property rentals;
searching for a listing of properties based on said search request, said listing comprising property information associated with each property, said property information comprising an initial price set by an owner of each property and information describing each property;
causing said listing of properties to be communicated to said user;
receiving a user offer to reserve a first property of said listing, said user offer comprising a price request below the initial price from the user and payment information associated with an account of said user;
determining a status of said user offer, said status based upon an acceptance, denial or counter-offer from an owner of said first property, said counter-offer comprising a second price set by the first owner in response to said user price request;
automatically charging said account and reserving said first property for said user upon said status indicating said acceptance of said user offer;
stopping further communication between said user and first owner for said first property upon said status indicating said denial of said user offer; and
communicating, over the network, said counter-offer to said user upon said status indicating said counter-offer.

20. The system of claim 19, further comprising:
determining a status of said counter-offer, said counter-offer status based upon an acceptance or denial from said user;
automatically charging said account and reserving said first property for said user upon said counter-offer status indicating said acceptance of said counter-offer; and
stopping further communication between said user and first owner for first property upon said counter-offer status indicating said denial of said counter-offer.
